(19) United States
(12) Patent Application Publication
(10) Pub. No.: US 2022/0347497 A1
(43) Pub. Date: Nov. 3, 2022

(54) METHODS OF ASSEMBLING PERSONAL AIR PURIFYING RESPIRATORS

(71) Applicant: FORD GLOBAL TECHNOLOGIES, LLC, Dearborn, MI (US)

(72) Inventors: John Wesley Wilds, Grosse Ile, MI (US); Manfred Koberstein, Troy, MI (US); Clay Wesley Maranville, Ypsilanti, MI (US); William S. Johnston, South Lyon, MI (US); James Allan Birley, Bingham Farms, MI (US); Scott Allan Hanson, Ann Arbor, MI (US); John Martin Salens, Novi, MI (US); Blake Gecse, LaSalle (CA); Ryan M. VanBelle, Canton, MI (US); Meghan Christine Shinska, Canton, MI (US); Mark William Miller, Royal Oak, MI (US); Jennifer A. Herr-Rathke, Plymouth, MI (US); Daniel Heilman, Ann Arbor, MI (US)

(21) Appl. No.: 17/243,106

(22) Filed: Apr. 28, 2021

(51) Int. Cl. A62B 18/00; A62B 7/10; A62B 18/08

(52) U.S. Cl. CPC A62B 18/006; A62B 7/10; A62B 18/08

(57) ABSTRACT

A method of assembling a personal air purifying respirator includes assembling a housing including a blower disposed therein, a filter cavity, and an outlet manifold; installing a filter on the housing; attaching a filter cover to the housing with the filter cover disposed over the filter, wherein the filter cover defines an air inlet; and testing the filter including energizing the blower, introducing a testing aerosol into the air inlet, and measuring air exiting the outlet manifold.

### TECHNICAL FIELD

The present disclosure relates to personal air purifying respirators and more particularly to methods of assembly.

### BACKGROUND

Personal air purifying respirators are used to filter contaminated air and provide clean, breathable air to a user. The respirator includes a filter configured to block pathogens, dirt, and other contaminations from entering the user's respiratory system.

### SUMMARY

According to one embodiment, a method of assembling a personal air purifying respirator includes installing a blower in a housing and installing a circuit into the housing. The circuit is configured to control a speed of the blower based on a position of a potentiometer associated with the circuit. The method further includes calibrating the potentiometer including connecting an outlet manifold of the housing to an airflow meter, operating the blower, and adjusting the potentiometer such that the airflow meter measures a target airflow.

According to another embodiment, a method of assembling a personal air purifying respirator includes assembling a housing including a blower disposed therein, a filter cavity, and an outlet manifold; installing a filter on the housing; attaching a filter cover to the housing with the filter cover disposed over the filter, wherein the filter cover defines an air inlet; and testing the filter including energizing the blower, introducing a testing aerosol into the air inlet, and measuring air exiting the outlet manifold.

According to yet another embodiment, a method of assembling a personal air purifying respirator includes assembling first and second housing portions to form a housing having a battery-and-electronics chamber, a filter sealing surface, and a blower disposed within the housing and installing a filter on the housing such that a seal of the filter is disposed against the filter sealing surface. The method further includes attaching a filter cover to the housing with the filter cover disposed over the filter, wherein the filter cover defines an air inlet. The method also includes installing a circuit board, into the battery-and-electronics chamber. The circuit board is configured to control the blower and has a potentiometer that is adjustable to change a speed of the blower. The method further includes calibrating the potentiometer, which comprises connecting an outlet manifold of the housing to an airflow meter, operating the blower, and adjusting the potentiometer such that the airflow meter measures a target airflow. The method also includes testing the filter including energizing the blower, introducing a testing aerosol into the air inlet, and measuring air exiting the outlet manifold.

### BRIEF DESCRIPTION OF THE DRAWINGS

FIG. 1 is a perspective view of a personal air purifying respirator.

FIG. 2 is an exploded view of the respirator.

FIG. 3 is a side view, in cross section, of an air purifying unit of the respirator.

FIGS. 4A-4D show a flow chart and accompanying illustrations of a method of assembling a personal air purifying respirator.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

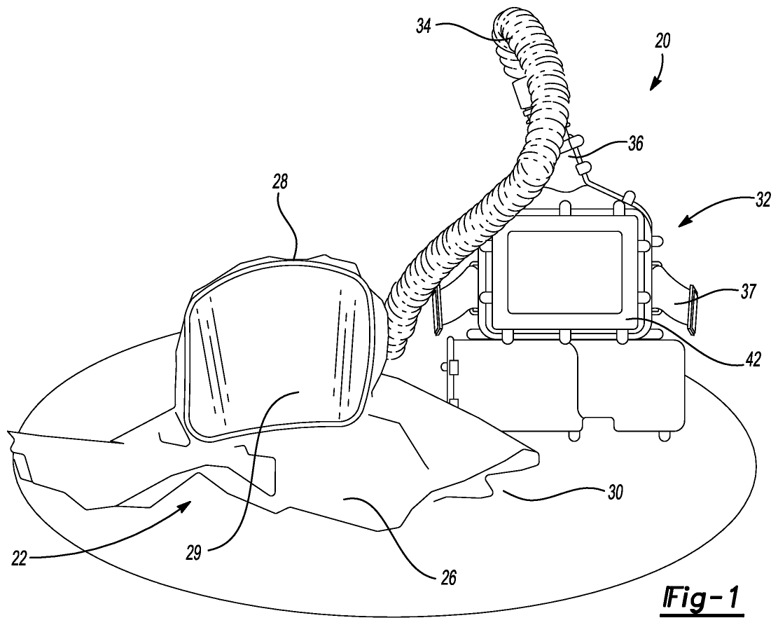

Referring to FIG. 1, a personal air purifying respirator 20 includes a head unit 22 to be worn over a user's head and face. The head unit 22 includes a face shield 24, such as clear glass or plastic, and a hood 26. The hood 26 includes an upper portion 28 that is received over the head and a skirt portion 30 that depends downwardly and is received over the shoulders. The head unit 22 is designed to provide a sealed environment around the users face to prevent contaminants from entering therein. The hood 26 includes an air inlet port (not visible) that receives purified air from the purifying unit 32. For example, a flexible hose 34 connects the outlet manifold 36 of the purifying unit 32 to the inlet port of the hood 26. The purifying unit 32 may the designed to be worn on a users back and may include a belt 37 for securing the unit 32 to the user.

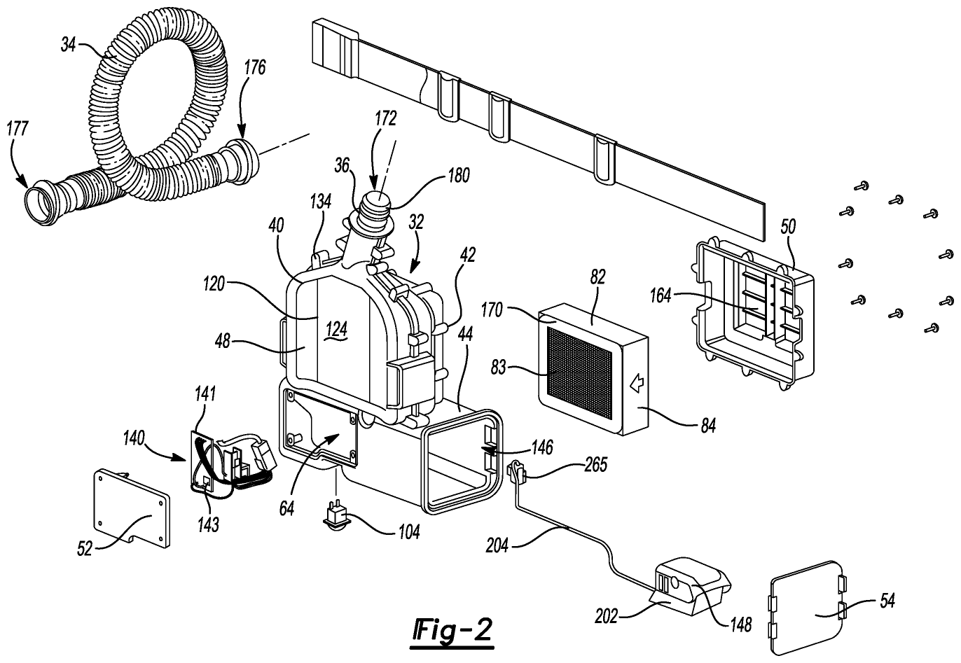

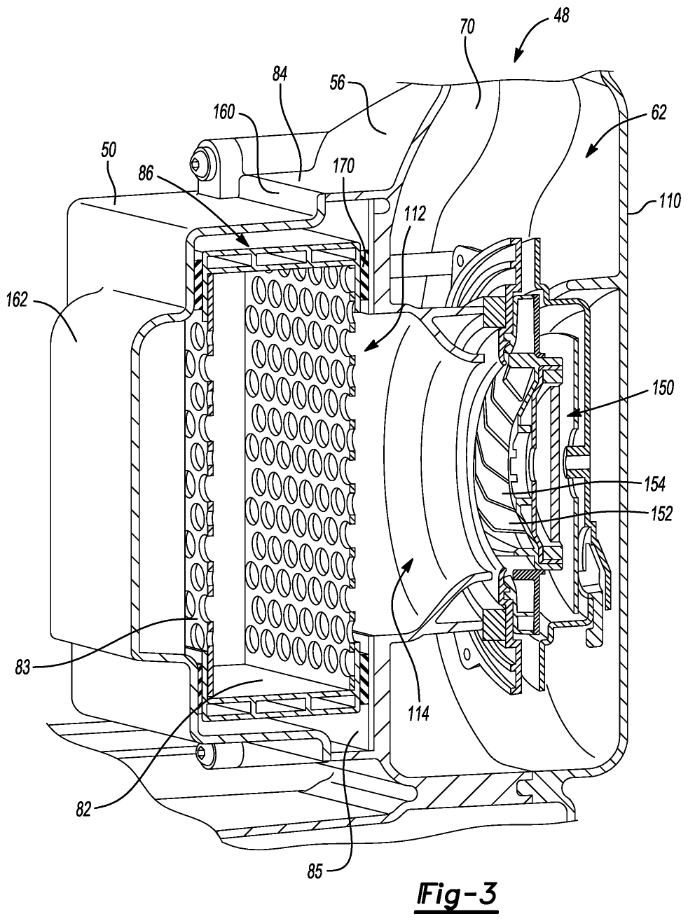

Referring to FIGS. 2 and 3, the purifying unit 32 may generally include a blower portion 40, a filter portion 42, and an electronics-and-battery portion 44. The purifying unit 32 includes a housing 48, a filter cover 50, an electronics cover 52, and a battery cover 54. The housing 48 and covers may be formed of injection-molded plastic. In the illustrated embodiment, six injection molded plastic components are used. The housing 48 may be formed of two plastic-injection molded components (halves) that are secured together, e.g., a clamshell design. Use of the term “housing halves” does not necessarily mean that each half forms exactly half of the housing.

The housing 48 may include a back housing portion (or half) 56 and a front housing portion (or half) 110 that may roughly define the other half of the housing 48. The housing 48 defines a blower cavity 62. A blower 150 is disposed in the blower cavity 62. The blower 150 includes a fan 152 operably coupled to a motor assembly. The fan 152 may be an axial fan that draws air into the center of the fan 152 and expels air radially outward with a series of vanes (or blades) 154.

The motor assembly includes a frame that supports an electric motor. The electric motor may include a stationary stator and a rotor that is mounted for rotation within the stator. A spindle of the motor assembly is rotationally fixed to the rotor. The fan 154 is mounted to the spindle to operably coupled the fan 154 to the motor. When the motor is energized, the fan 154 is rotated to provide a flow of air to the head unit 22. The blower 150 may be a high-efficiency blower that enables the battery 148 to operate for an extended period of time, e.g., 12 hours, without requiring recharging or battery change out.

The front housing portion 110 cooperates with the filer cover 50 to define a filter cavity 86. The filter cavity 86 is in fluid communication with the blower cavity 62 via an opening 112 and a funnel-shaped structure 114 of the back housing portion 56.

The filter 82 is disposed upstream of the blower 154 within the filter cavity 86 of the housing 42. The filter cover 50 is connected to the housing 42 to seal the cavity 86. The filter cover 50 includes walls 160 that engage with the walls 84 of the back portion 56. A gasket, adhesive or other sealing means may be placed between the edges of the walls 84 and 160 to provide an airtight seal. The cover 50 includes a face 162 that connects between the walls 160. The cover face 162 defines a plurality of air inlets 164, e.g., slots, slits, holes, etc., that allow raw air into the filter cavity 86.

The filter 82 is received within the filter cavity 86 with a gasket 170 disposed against a sealing surface 85 of the housing 56. The gasket 170 is configured to create an airtight seal to prevent contaminated air from entering into the blower cavity 62.

During operation, the blower 150 draws raw air into the filter cavity 86 through the air inlets 164. The air then passes through a filter medium 83 of the filter 82, which removes contaminants such as viruses, pathogens, bacteria, molds, dirt, chemicals, and other unwanted substances. The filter 82 may be a high-efficiency particulate air (HEPA) filter. Cleaned air emerges from the clean side of the filter 82 and is guided to the blower cavity 62 by the tapered walls 114. The rotating vanes 154 force the air radially outward and through the outlet manifold 36.

The outlet manifold 36 defines an outlet port 172, e.g., a circular hole defined by the cooperation of the front and back housing portions 56 and 110. The outlet manifold 36 is configured to connect to the inlet fitting 176 of the hose 34 either directly or via an adapter. The other fitting 177 of the hose is configured to connect with the inlet port on the head unit 22 or an adapter.

The front and back housing portions 56 and 110 also cooperate to define the electronics-and-battery portion 44. The portion 44 includes a cavity or compartment 64 that receives the battery and the electronics of the unit. Within the cavity 64 are at least a circuit 140 that includes a controller or micro-processor configured to at least operate the blower, an ON/OFF switch 104, a battery dock 202, the battery 148, and supporting components, e.g., wires, a circuit board, etc. The electronics-and-battery portion 44 has an open end 146 that allows access to the rechargeable battery 148 that is removable from the unit 36. The battery cover 54 is connectable to the opened end 146 to close the electronics-and-battery chamber 64. The cover 54 may be secured by a plurality of fasteners, clips, snaps, hinges, or the like. The circuit 140 and other components are accessible via the cover 52.

The ON/OFF switch 104 is electrically connected to the circuitry 140. Pressing the switch 104 ON causes the circuitry 140 to activate the blower 150 and begin operation of the respirator 20. Similarly, pressing the switch 104 OFF ceases operation of the blower. The switch 104 may be a toggle switch for example having an ON position and an OFF position. Alternatively, the switch 104 may be a push-button that cycles between ON and OFF each time it is pressed. Of course, other types of ON-OFF switches are known and may be used.

Control circuit 140 is powered by the battery 148. The battery 148 is configured to be removably connected to the unit 32. The battery 148 may be a lithium-ion battery or other suitable chemistry. The battery 148 is a rechargeable battery that may be removed from the unit and plugged into a charging station (not shown) to recharge the battery. This allows the respirator 20 to be continuously utilized whenever a charged battery is available. For example, the respirator 20 may be provided with two or more batteries allowing one of the batteries to be charged while the other batteries used so that at any given time, a functionally charged battery is available. The battery may also be chargeable within the unit.

The battery dock 202 includes terminals configured to connect to terminals of the battery 148. The battery dock 202 may be connected to the circuit 140 by one or more wires 204 and a connector 205. The battery dock 202 may include retention features that cooperate with retention features on the outer housing of the battery 148 to provide a secure connection therebetween. These retention features may include release mechanisms allowing the battery 148 to be disconnected from the dock 202. The cover 54 is removable, or otherwise openable, to allow access to the battery 148 through the open end 146.

The circuitry 140 may include a circuit board 141 such as a printed circuit board that supports a plurality of electronic components such as the CPU and others. The flow rate of the respirator may be modified by changing a speed of the blower. The circuitry 140 is configured to control the speed of the blower. In one or more embodiments, a variable resistor (e.g., potentiometer meter) 143 may be provided on the circuit board 141 and adjustable to control the speed of the fan 152. The potentiometer 143 may include an adjustment screw that is manually actuatable to set the fan speed to the desired speed.

Further discussion of personal air purifying respirators can be found in Applicant's co-pending patent application (Ser. No. 17/149,467, filed Jan. 14, 2021) the contents of which are incorporated by reference herein in their entirety.

The following Figures and related text describe methods for assembling personal air purifying respirators. For ease of description, the methods may be described in conjunction with the above example embodiment, but are not limited thereto. The methods may be represented by flow charts or similar diagrams in one or more figures. These figures provide representative methods or processes that may be implemented to manufacture the above-described apparatuses. The various steps illustrated may be performed in the sequence illustrated, in parallel, in a different sequence, or in some cases omitted. Although not always explicitly illustrated, one of ordinary skill in the art will recognize that one or more of the illustrated steps may be repeatedly performed depending upon the particular process.

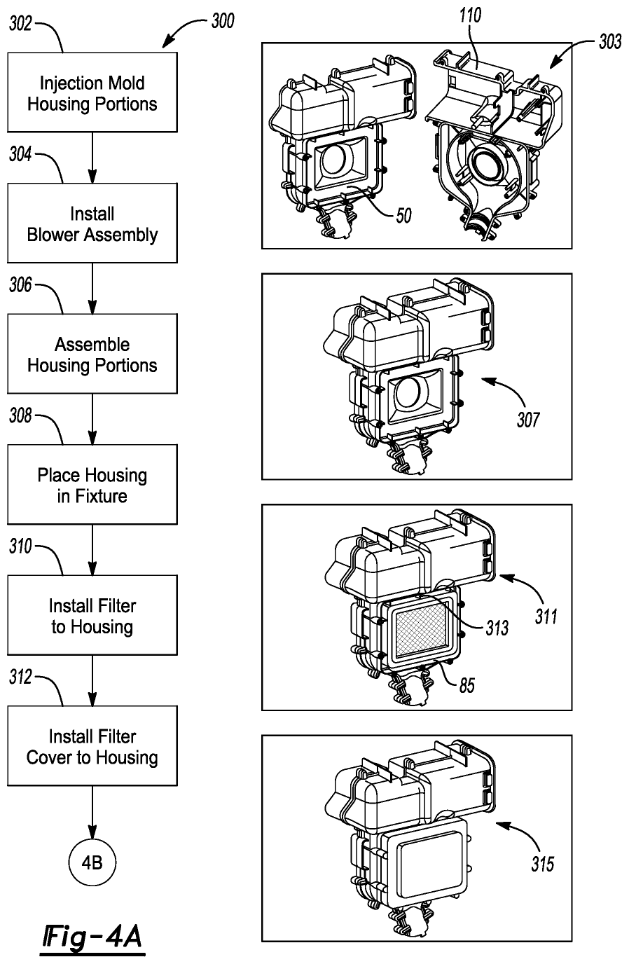

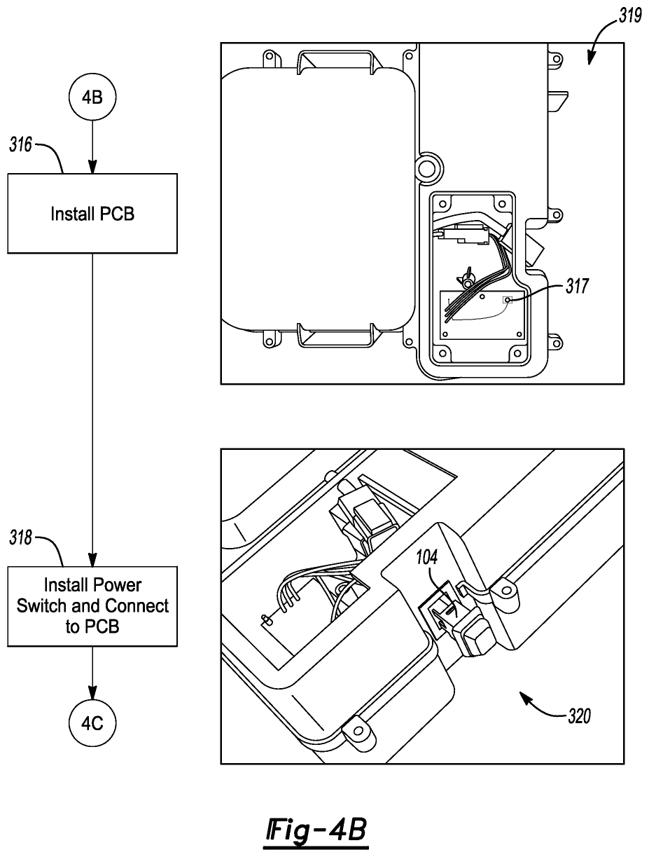

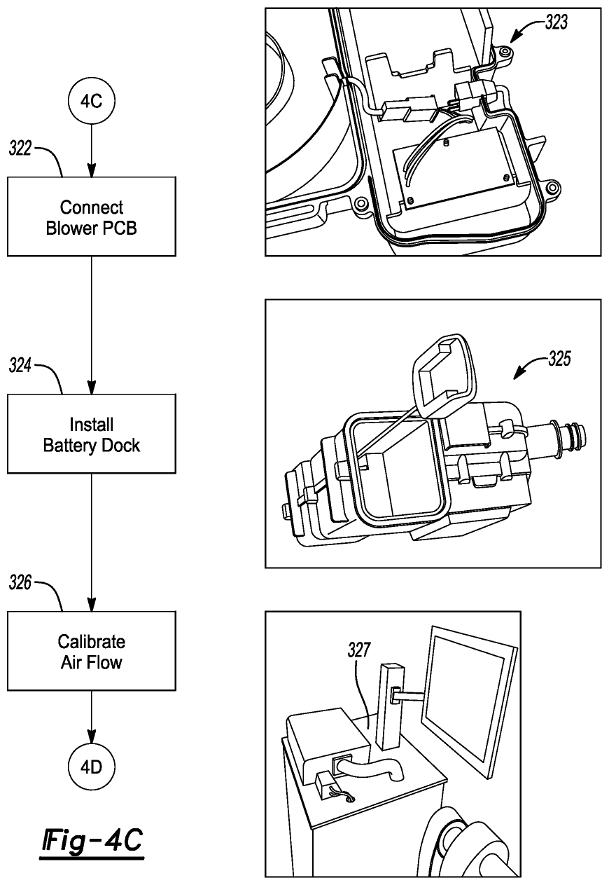

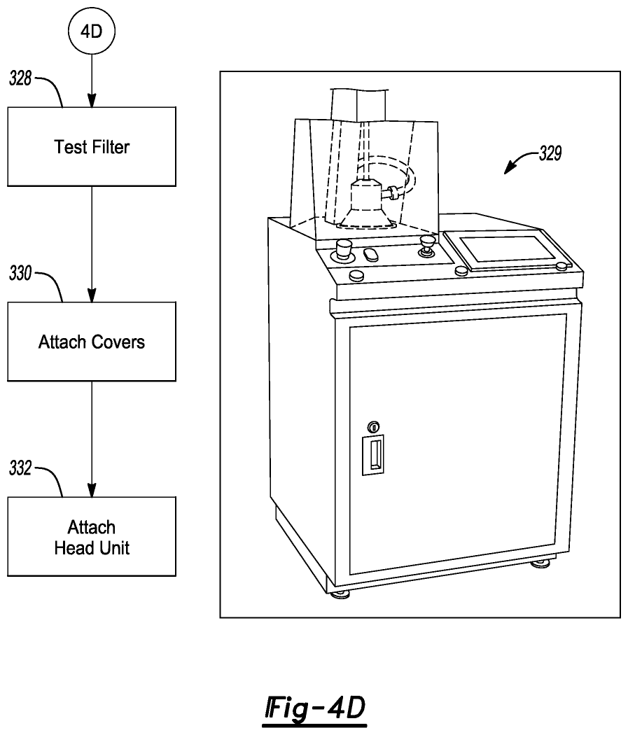

Referring to FIGS. 4A-4D, a method 300 of assembling a personal air respirator includes injecting molding housing portions at operation 302. An example of this is shown in the illustration 303. The housing portions may be the above-described portions 56 and 110. In alternative embodiments, the portions may be formed by techniques other than injection molding. In operation 304, the blower assembly is installed in one of the housing portions. The housing portions may then be assembled together to form a housing at operation 306. An example of this is shown in illustration 307. At this stage of assembly, the blower is now installed within the blower cavity and the housing now forms the electronics-and-battery cavity and the outlet manifold. The housing may be attached to a fixture other support structure with the filter cavity facing up. A filter is installed in the filter cavity of the housing at operation 310. An example of this is shown in illustration 311. The housing may include a filter sealing surface 85 and a plurality of alignment tabs 313. The filter is installed on the filter sealing surface 85 such that a gasket or seal of the filter, e.g., seal 170, is seated thereon to create an airtight seal. The alignment tabs 313 engage with the border of the filter to center the filter in the filter cavity. Once the filter is correctly installed, the filter cover is attached to the housing at operation 312 (as shown in illustration 315.

The housing may then be removed from the fixture, flipped over, and re-fixtured or flipped over in the fixture so that so that the battery-and-electronics cavity is accessible. In operation 316, the printed circuit board and the associated circuitry is installed within the battery-and-electronics cavity. An example of this is shown in illustration 319. The circuit board is installed so that the screw 317 of the potentiometer is assessable.

At operation 318, the power switch, e.g., switch 104, is installed through an opening in the housing. An example of this is shown in illustration 320. The power switch may include wires that are connected to the circuit board. At operation 322, the blower assembly is connected to the printed circuit board. For example, lead wires of the blower motor may be electrically connected to the printed circuit board by connecting to connectors together as shown in illustration 323. At operation 324, the battery dock is installed within the battery compartment. The battery dock may include associated wires that electrically connect to the circuit board. An example of this is shown in illustration 325.

Following operation 324, most major components of the purifying unit are assembled and the assembly is now ready to be calibrated and tested on a testing unit 327. At operation 326, the airflow is calibrated using the testing unit 327. As discussed above, a potentiometer or the like of the circuit may be used to control the speed of the blower. At operation 326, the purifying unit may be instrumented with an airflow meter of the testing unit 327, such as at the outlet manifold of the purifying unit. The purifying unit is energized and turned ON so that the blower produces an output of air. The airflow is measured and the potentiometer actuated until the desired airflow is achieved. For example, the adjustment screw 317 of the potentiometer meter may be turned in and out. Once the desired calibration is achieved, the potentiometer meter may be sealed to prevent further calibration. For example, an epoxy, silicone, or other adhesive, may encase the adjustment screw 317 to prevent rotation.

The filter may be tested at operation 328 using another testing unit 329. The mostly or fully assembled purifying unit is placed on a testing machine, e.g., TSI 8130 tester unit, with the filter cover facing down and the adapter hose attached to the outlet nozzle. The testing may be automatically conducted by the unit using a pre-set process. Once the test is complete, the unit indicates whether the filter passed or failed the test. The tester may introduce a testing aerosol into the air inlet, and measuring air exiting the outlet manifold. Based unit passes the test based on the amount of aerosol sensed in the outlet manifold.

Once the testing and calibration are complete, the battery and circuit board covers are attached to the housing at operation 330. At operation 332, the purifying unit is connected to the head unit, such as by connecting the hose to the outlet manifold.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of assembling a personal air purifying respirator comprising:
installing a blower in a housing;
installing a circuit into the housing, the circuit being configured to control a speed of the blower based on a position of a potentiometer associated with the circuit; and
calibrating the potentiometer including connecting an outlet manifold of the housing to an airflow meter, operating the blower, and adjusting the potentiometer such that the airflow meter measures a target airflow.

2. The method of claim 1, wherein the potentiometer includes an adjustment screw, and the calibrating further includes turning the screw.

3. The method of claim 2 further comprising immobilizing the screw after the calibration is complete.

4. The method of claim 3, wherein the immobilizing includes applying a sealant over the screw.

5. The method of claim 1 further comprising:
installing a filter in the housing; and
testing the filter including energizing the blower, introducing a testing aerosol into the air inlet, and measuring air exiting the outlet manifold.

6. The method of claim 5 further comprising placing the personal air purifying respirator on a TSI 8130 testing unit.

7. The method of claim 1 further comprising connecting a battery dock to the circuit board and securing the battery dock within the housing.

8. The method of claim 7, wherein the battery dock includes an associated removable and rechargeable battery that is receivable within the housing.

9. The method of claim 1 further comprising connecting a head unit in fluid communication the outlet manifold.

10. A method of assembling a personal air purifying respirator comprising:
assembling a housing including a blower disposed therein, a filter cavity, and an outlet manifold;
installing a filter on the housing;
attaching a filter cover to the housing with the filter cover disposed over the filter, wherein the filter cover defines an air inlet; and
testing the filter including energizing the blower, introducing a testing aerosol into the air inlet, and measuring air exiting the outlet manifold.

11. The method of claim 10 further comprising installing a circuit into the housing, the circuit being configured to control a speed of the blower based on a position of a potentiometer associated with the circuit.

12. The method of claim 11 further comprising calibrating the potentiometer including connecting the outlet manifold to an airflow meter, operating the blower, and adjusting the potentiometer such that the airflow meter measures a target airflow.

13. The method of claim 11 further comprising connecting a battery dock to the circuit board and securing the battery dock within the housing, wherein the battery dock includes an associated removable and rechargeable battery that is receivable within the housing.

14. The method of claim 10 further comprising:
attaching a hose to a head unit; and
attaching the hose to the outlet manifold.

15. A method of assembling a personal air purifying respirator comprising:
assembling first and second housing portions to form a housing having a battery-and-electronics chamber, a filter sealing surface, and a blower disposed within the housing;
installing a filter on the housing such that a seal of the filter is disposed against the filter sealing surface;
attaching a filter cover to the housing with the filter cover disposed over the filter, wherein the filter cover defines an air inlet;
installing a circuit board, into the battery-and-electronics chamber, the circuit board being configured to control the blower and including a potentiometer that is adjustable to change a speed of the blower;
calibrating the potentiometer including connecting an outlet manifold of the housing to an airflow meter, operating the blower, and adjusting the potentiometer such that the airflow meter measures a target airflow; and
testing the filter including energizing the blower, introducing a testing aerosol into the air inlet, and measuring air exiting the outlet manifold.

16. A method of claim 15, wherein the potentiometer includes an adjustment screw, and the calibrating the potentiometer further includes turning the screw.

17. The method of claim 16 further comprising immobilizing the screw after the calibration is complete.

18. The method of claim 17, wherein the immobilizing includes applying a sealant over the screw.

19. The method of claim 15 further comprising connecting a battery dock to the circuit board and securing the battery dock within the housing.

20. The method of claim 19, wherein the battery dock includes an associated removable and rechargeable battery that is receivable within the housing.
